(19) United States
(12) Patent Application Publication
(10) Pub. No.: US 2026/0332993 A1
(43) Pub. Date: Oct. 22, 2026

(54) FAST RICH COMMUNICATION SERVICES/OVER-THE-TOP-TO-SMS FALLBACK

(71) Applicant: Verizon Patent and Licensing Inc., Basking Ridge, NJ (US)

(72) Inventors: Jeremy Nacer, Boca Raton, FL (US); Binaben Dipesh Patel, Princeton, NJ (US); Hongkun Li, Basking Ridge, NJ (US)

(21) Appl. No.: 19/181,742

(22) Filed: Apr. 17, 2025

(51) Int. Cl. H04W 4/14; H04L 65/1016; H04W 76/20; H04W 84/12

(52) U.S. Cl. CPC H04W 4/14; H04L 65/1016; H04W 76/20; H04W 84/12

(57) ABSTRACT

A first device engages in Rich Communication Services (RCS) or Over-the-Top (OTT) messaging with a second device. The first device determines that it no longer has a data connection, disables the RCS or OTT messaging, and sets an indicator, that indicates that the first device has no data connection, in an information element of a header field of a Short Message Service (SMS) message. The first device sends the SMS message to the second device.

### BACKGROUND

Short Message Service (SMS), commonly referred to as “text messaging,” is a wireless network-implemented protocol and service that enables wireless network subscribers to send messages, consisting of text typically having a limited number of characters, to other wireless network subscribers. Unlike other app-based messaging services, wireless network subscribers do not need to subscribe to a data plan with their wireless network provider to send and receive SMS messages. Spare bandwidth available on wireless voice networks is typically used for sending and receiving SMS messages.

Over-the-Top (OTT) messaging involves instant messaging platforms that use a public network connection (e.g., the Internet or Wi-Fi connected to the Internet) to transmit communications between mobile devices, instead of a mobile network. OTT messaging, therefore, operates “over the top of,” or above, wireless networks and enables mobile devices, that have a data connection (e.g., an Internet Protocol (IP) connection) to send and receive messages over the public network. OTT messaging may involve a third-party application (app) that is downloaded to a mobile device, as compared to an SMS app that is usually a native app on mobile devices. OTT messaging is often free, whereas SMS messaging is usually charged per text message sent, unless the mobile subscriber has subscribed to an unlimited SMS messaging plan.

Rich Communication Services (RCS) is a communication protocol standard for instant messaging that supports, among other data, the sending and receiving of high-resolution images and videos between mobile devices. RCS, like SMS, is typically natively integrated on mobile devices and supports additional features such as location sharing, multimedia sharing, and video calling. RCS is IP-based and requires some form of a data connection, such as a mobile data connection, an Internet data connection, or a Wi-Fi data connection, for transmitting communications between mobile devices.

### BRIEF DESCRIPTION OF THE DRAWINGS

FIG. 1 illustrates an example of a network environment in which OTT/RCS fallback to SMS over Non-Access Stratum (NAS) or SMS over Internet Protocol (IP) Multimedia Subsystem (IMS) may be implemented;

FIG. 2 depicts an example of components of terrestrial mobile networks and their interconnection with a data network and a device;

FIG. 3 illustrates example components of an IMS network;

FIG. 4 depicts an example overview of a fallback process from RCS/OTT messaging to SMS messaging;

FIG. 5 is a diagram that depicts example components of a device that may correspond to the devices, or that may execute functions, that are depicted and described herein;

FIGS. 6A and 6B are flow diagrams of an example process for initiating RCS/OTT to SMS fallback based on the loss of a data connection at a wireless device; and

FIGS. 7A and 7B depict examples of operations, messages, and data flows associated with the process of FIGS. 6A and 6B.

### DETAILED DESCRIPTION OF EXAMPLE EMBODIMENTS

The following detailed description refers to the accompanying drawings. The same reference numbers in different drawings may identify the same or similar elements. The following detailed description does not limit the invention.

RCS-capable wireless devices, or wireless devices using OTT apps for messaging, may send/receive RCS or OTT messaging when both devices involved in the RCS/OTT messaging have a data connection. If device A loses its data connection, such as losing its Wi-Fi connection and/or its mobile network data connection, then device A will no longer be able to send/receive RCS or OTT messages with a device B. Further, device B will not fallback to SMS messaging with device A until it becomes aware of device A’s RCS or OTT offline status. Thus, all RCS messaging or OTT messaging from device B to device A before SMS fallback will fail, requiring the user of device B to either manually re-send failed RCS or OTT messages as SMS messages, or device B has to wait a period of time (e.g., > five minutes) for triggering of auto-fallback to SMS. This triggering of fallback to SMS relies on an application layer solution, which requires back-and-forth communication between device A and device B, and the RCS/OTT message server, to determine if a device is RCS/OTT online or offline. This lengthy back-and-forth communication degrades the device users’ messaging experiences.

Embodiments described herein use an Information Element (IE) in a header field (e.g., the Transport Protocol-User Data (TP-UD) header field) of an SMS message to expressly provide an indication, to a device B involved in an RCS/OTT messaging session with a device A, that device A has lost its data connection and that device B should implement RCS/OTT fallback to SMS for messaging with Device A. Subsequent to switching mode from RCS/OTT messaging to SMS messaging based on device A losing its data connection, device B may determine whether to switch mode back to RCS/OTT messaging with device A if device B receives an RCS/OTT message from device A, or if device B receives a device A updated RCS/OTT “on” or “online” status from the mobile network or from the RCS/OTT messaging server. SMS messaging, as described herein, may use the Non-Access Stratum (NAS) or Internet Protocol (IP) Multimedia Subsystem (IMS) protocols for delivering messages between two devices, such as a device A and a device B.

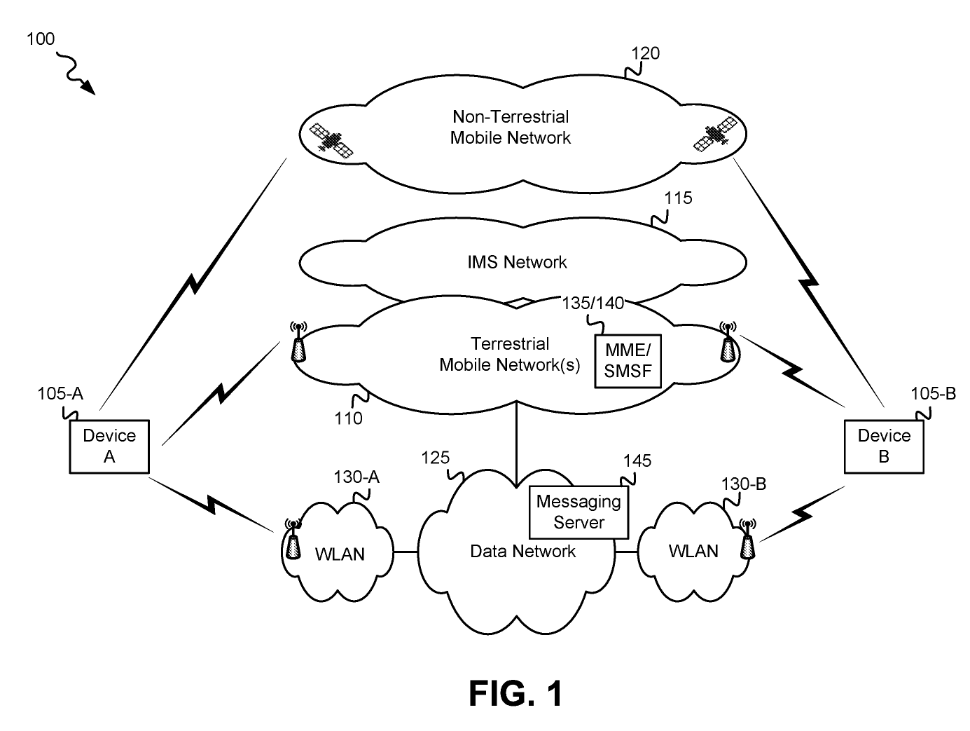

FIG. 1 illustrates an example of a network environment 100 in which OTT/RCS fallback to SMS over NAS or SMS over IMS may be implemented, as described herein. As shown, the example network environment 100 may include a device A 105-A (referred to herein as “device 105-A”), a device B 105-B (referred to herein as “device 105-B”), a terrestrial mobile network(s) 110, an IMS network 115, a non-terrestrial mobile network 120, a data network 125, a Wireless Local Area Network (WLAN) 130-A, and a WLAN 130-B. n

Devices 150-A and 150-B (generically referred to herein as “Device 150” or “devices 105”) may each include a User Equipment device (UE) that may further include any type of electronic device having a wireless communication capability. Each device 105 may include, for example, a laptop, palmtop, desktop, or tablet computer; a cellular phone (e.g., a “smart” phone); a Voice over Internet Protocol (VoIP) phone; a smart television (TV); an audio speaker (e.g., a “smart” speaker); a video gaming device; a music player (e.g., a digital audio player); a digital camera; a device in a vehicle; a wireless telematics device; an Augmented Reality/Virtual Reality (AR/VR) headset or glasses; or an Internet of Things (IoT) or Machine-to-Machine (M2M) device. A user (not shown) may carry, use, administer, and/or operate each device 105. Though only two devices 105 are depicted in FIG. 1, network environment 100 may include multiple devices 105, which may communicate among one another via terrestrial mobile network(s) 110, IMS network 115, non-terrestrial mobile network 120, and/or WLAN 130 and data network 125. In the example network environment 100 of FIG. 1, messages sent from device 105-A are called Mobile-Originated (MO) messages and the messages, when received at device 105-B, are called Mobile-Terminated (MT) messages. Conversely, MO messages may be sent from device B 105-B for receipt at device A 105-A as MT messages.

Terrestrial mobile network(s) 110 may include one or more of any type of Public Land Mobile Networks (PLMNs). Terrestrial mobile network(s) 110 may include, for example, one or more Fourth Generation (4G) Long-Term Evolution (LTE) networks, one or more Next Generation mobile networks (e.g., Fifth Generation (5G) networks, Sixth Generation (6G) networks), and/or one or more hybrid mobile networks (e.g., a Next Generation/4G hybrid network, such as a 4G with 5G Non-Stand-Alone (NSA) hybrid network). Each Next Generation mobile network may include evolved network components (e.g., future generation components) relative to an LTE network, such as a 4G or 4.5G LTE mobile network. As shown in FIG. 1, terrestrial mobile network(s) may include a Mobility Management Entity (MME) 135 or an SMS Function (SMSF) 140. MME 135 or SMSF 140 may act as an intermediary for routing SMS over NAS messages between devices (e.g., between device 105-A and device 105-B), and are described further below.

IMS network 115 includes a network that uses the Session Initiation Protocol (SIP) for voice and multimedia session control, such as for creating, modifying and terminating sessions between devices (e.g. device A 105-A and device B 105-B). Non-terrestrial mobile network 120 may include one or more of any type of satellite mobile network that enables devices 105-A and 105-B to communicate with one another via satellites orbiting the earth in, for example, geostationary earth orbit (GEO), medium earth orbit (MEO), low earth orbit (LEO), highly elliptical orbit (HEO), or polar orbit (PO). Though not shown, non-terrestrial mobile network 120 may additionally include ground-based components (e.g., dishes for uplink/downlink to/from the orbiting satellites) that operate to connect the orbiting components with terrestrial networks, such as, for example, data network 125 or terrestrial mobile network(s) 110.

Data network 125 may include one or more interconnected networks, such as, for example, local area networks (LANs), wide area networks (WANs), metropolitan area networks (MANs), telecommunications networks (e.g., Public Switched Telephone Networks (PSTNs)), cable networks (e.g., optical cable networks), Multi-Access Edge Computing networks (MECs), and/or the Internet. In some circumstances, data network 125 may include one or more interconnected public packet-switching networks. As shown in FIG. 1, data network 125 may include a messaging server 145 that may act as an intermediary for routing and forwarding RCS or OTT messages between devices (e.g., devices 105-A and 105-B). Though a single messaging server 145 is shown, data network 125 may include multiple messaging servers 145 such as, for example, an RCS messaging server 145 for forwarding RCS messages between devices and an OTT messaging server 145 for forwarding messages associated with a particular OTT application between devices. In some implementations, a messaging server 145 may alternatively be located in terrestrial mobile network(s) 110 instead of data network 125.

WLAN 130-A and WLAN 130-B may each include, for example, a Wi-Fi network that interconnects with data network 125 and enables device 105-A and device 105-B to engage in messaging sessions with one another via data network 125. Other types of WLANs may, however, be implemented in network environment 100 and may be used by devices 105-A and 105-B to connect to data network 125.

The configuration of network components of network environment 100 shown in FIG. 1 is for illustrative purposes. Other configurations may be implemented. Therefore, network environment 100 may include additional, fewer, and/or different networks or networks components that may be configured in a different arrangement than that depicted in FIG. 1. For example, network environment 100 may include numerous devices 105 (e.g., greater than 2). Further, network environment 100 may include additional networks not shown in FIG. 1.

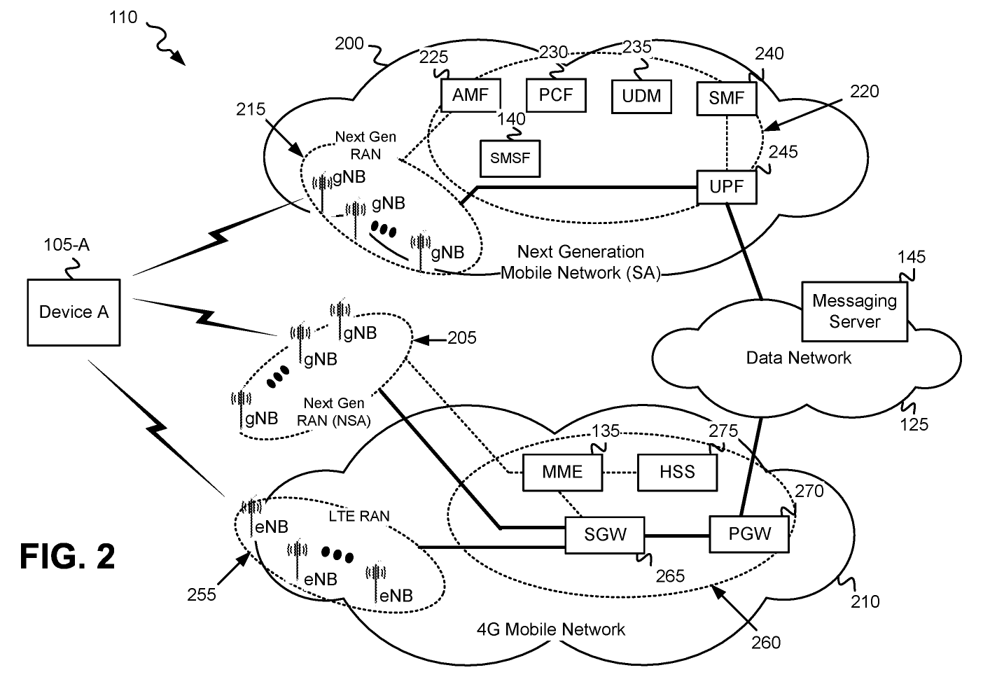

FIG. 2 depicts an example of components of terrestrial mobile network(s) 110 and their interconnection with data network 125 and device 105-A. As shown terrestrial mobile network(s) 110 may include a Stand-Alone (SA) Next Generation mobile network 200, a Non-Stand-Alone (NSA) Next Generation Radio Access Network (RAN), and a Fourth Generation (4G) mobile network 210.

SA Next Generation mobile network 200 may include a Next Generation RAN 215 and a core network 220. Next Generation RAN 215 may include multiple Next Generation nodeBs (gNBs) that include, among other components, transceivers and antennas for enabling the establishment of wireless connections with wireless devices, such as devices 105-A and 105-B. Core network 220 may include, among other nodes, functions, and components, an Access and Mobility Management Function (AMF) 225, a Policy Control Function (PCF) 230, a User Data Management (UDM) function 235, a Session Management Function (SMF) 240, a User Plane Function (UPF) 245, and SMSF 140.

AMF 225 may include functions executed by a network device to perform device-based authentication, authorization, and mobility management for devices 105.

PCF 230 may include functions executed by a network device to implement policy control for service data flows and Protocol Data Unit (PDU) session related policy control. For example, PCF 230 may store and/or generate policy rule sets that may apply to traffic from different devices (e.g., devices 105-A and 105-B) and may supply one or more policy rules to SMF 240 handling a session.

UDM 235 may include functions executed by a network device to manage data for user access authorization, user registration, and data network profiles. UDM 235 may include, or operate in conjunction with, a User Data Repository (UDR - not shown) which stores user data, such as customer profile information, customer authentication information, and encryption keys.

SMF 240 may include functions executed by a network device to perform session management and to select and control particular nodes (e.g., UPFs) for data transport, including applying policy rules received from PCF 230.

UPF 245 may include functions executed by a network device to act as a router and a gateway between SA Next Generation Mobile network 200 and data network 125, and to forward session data between data network 125 and Next Generation RAN 215. Though only a single UPF 245 is shown in FIG. 2, Next Generation Mobile network 200 may include multiple UPFs 245 disposed at various geographic locations in network 200.

SMSF 140 may include functions executed by a network device to route and forward SMS messages (e.g., via NAS) between Next Generation mobile network 200 and other networks, or among devices connected to Next Generation mobile network 200, and to ensure the SMS messages are delivered to their intended recipients. SMSF 140 further provides interworking functionality to enable communication between it and SMS entities in other networks.

NSA Next Generation RAN 205 may include RAN components associated with a Next Generation network that interconnect with, and may be used by, non-Next Generation networks, such as, for example, 4G mobile network 210. Among other RAN components, RAN 205 may include gNBs that further include transceivers and antennas for enabling the establishment of wireless connections with wireless devices, such as devices 105-A and 105-B (not shown).

4G mobile network 210 may include an LTE RAN 255 and a core network 260. LTE RAN 255 may include multiple evolved nodeBs (eNBs) that include, among other components, transceivers and antennas for enabling the establishment of wireless connections with wireless devices, such as devices 105-A and 105-B. Core network 260 may include, among other nodes, functions, and components, an MME 135, a Serving Gateway (SGW) 265, a Packet Data Network (PDN) Gateway (PGW) 270, and a Home Subscriber Server (HSS) 275. As shown in FIG. 2, 4G mobile network 210 may interconnect with NSA Next Generation RAN 205 to enable 4G mobile network 210 to use enhanced capabilities of the Next Generation components of RAN 205. 4G mobile network 210 may use LTE RAN 255 instead of RAN 205, as an alternative to RAN 205, or in addition to RAN 205. NSA Next Generation RAN 205 and LTE RAN 255 may have co-extensive, or overlapping, wireless coverage for devices 105. 4G mobile network 210, when operating in conjunction with NSA Next Generation RAN 205, represents a hybrid 4G/Next Generation mobile network.

MME 135 includes functions executed by a network device to act as a control entity for 4G Mobile Network 210, including communicating with HSS 275 for user/device authentication and for user/device profile download. MME 135 further implements mobility management and session management functions for wireless devices (e.g., device 105-A, device 105-B) using, for example, NAS signaling. MME 135 may additionally route and forward SMS messages (e.g., via NAS) between 4G mobile network 210 and other networks, or among devices connected to 4G mobile network 210, to deliver the SMS messages to their intended recipients.

SGW 265 includes functions executed by a network device to route and forward session data between PGW 270 and LTE RAN 255 serving a device session. PGW 270 includes functions executed by a network device to act as a router and a gateway between 4G mobile network 210 and the external data network 125, and to forward session data between the data network 125 and LTE RAN 255 or NAS Next Generation RAN 205 (i.e., via SGW 265). HSS 275 includes functions executed by a network device to perform user authentication, session establishment, and/or access authorization based on stored subscriber service profiles.

The configuration of network components of terrestrial mobile network(s) 110 shown in FIG. 2 is for illustrative purposes. Other configurations may be implemented. Therefore, terrestrial mobile network(s) 110 may include additional, fewer, and/or different components that may be configured in a different arrangement than that depicted in FIG. 2. For example, terrestrial mobile network(s) 110 may include additional, or alternative, networks not shown in FIG. 2 Terrestrial mobile network(s) 110 may include fewer mobile networks than shown in FIG. 2. For example, terrestrial mobile network(s) 110 may include only SA Next Generation mobile network 200, only 4G mobile network 210, or only a hybrid 4G/Next Generation mobile network consisting of 4G mobile network 210 and NSA Next Generation RAN 205.

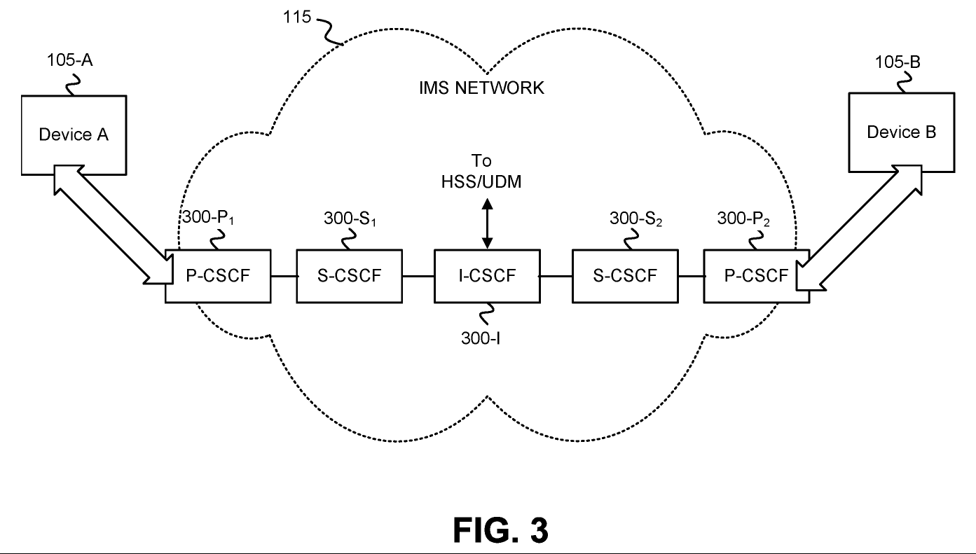

FIG. 3 illustrates example components of IMS network 115. As shown, IMS network 115 may include a Proxy Call Session Control Function (P-CSCF) 300-P₁, a serving Call Session Control Function (S-CSCF) 300-S₁, an Interrogating Call Session Control Function I-CSCF 300-I, a S-CSCF 300-S₂, and a P-CSCF 300-P₂. P-CSCF 300-P₁, S-CSCF 300-S₁, I-CSCF 300-I, S-CSCF 300-S₂, and P-CSCF 300-P₂may be generically and individually referred to herein as "CSCF 300".

P-CSCF 300-P₁ acts as an edge of IMS network 115 through which a device (e.g., device 105-A, device 105-B) obtains access. P-CSCF 300-P₁maintains an awareness of all IMS endpoints that are currently registered with IMS network 115, and performs various manipulations of SIP signaling messages that are arriving from, or being sent to, the IMS endpoints (e.g, devices 105-A and 105-B). P-CSCF 300-P₁maintains a connection with S-CSCF 300-S₁.

S-CSCF 300-S₁ processes all originating and terminating SIP requests and responses associated with endpoints registered with S-CSCF 300-S₁ (including device 105-A). S-CSCF 300-S₁ routes the SIP signaling towards its destination (e.g., towards P-CSCF 300-P₁and device 105-A), or towards device 105-B via I-CSCF 300-I. I-CSCF 300-I passes SIP signaling to/from S-CSCF 300-S₁and S-CSCF 300-S₂. I-CSCF 300-I queries HSS 275/UDM 235 (not shown in FIG. 3) to learn the identity of the S-CSCF assigned to a given device 105 so that it can properly forward the SIP signaling. HSS 275/UDM 235 may include a master user database (DB) that supports all of CSCFs 300 of IMS network 115. The master user DB stores user subscription-related information (e.g., subscriber profiles), and performs authentication and authorization of the user. The subscriber profiles stored in the master user DB may include an indication of whether a given user (of a device 105) has subscribed to usage of one or more particular networks (e.g., terrestrial mobile network(s) 110, IMS network 115, non-terrestrial mobile network 120).

S-CSCF 300-S₂processes all originating and terminating SIP requests and responses associated with endpoints registered with S-CSCF 300-S₂ (including device 105-B). S-CSCF 300-S₂ routes the SIP signaling towards its destination (e.g., towards P-CSCF 300-P₂and device 105-B), or towards device 105-A via I-CSCF 300-I. P-CSCF 300-P₂acts as an edge of IMS network 115 through which device 105-B obtains access. P-CSCF 300-P₂ maintains an awareness of all IMS endpoints that are currently registered with IMS network 115, and performs various manipulations of SIP signaling messages that are arriving from, or being sent to, the IMS endpoints (e.g., devices 105-A and 105-B). P-CSCF 300-P₂ maintains a connection with S-CSCF 300-S₂. S-CSCF 300-S₁ and S-CSCF 300-S₂ may obtain subscriber profile information from HSS 275/UDM 235 to determine whether device 105-A and/or device 105-B are subscribed to one or more particular networks (e.g., terrestrial mobile network(s) 110, IMS network 115, non-terrestrial mobile network 120). P-CSCF 300-P₁, S-CSCF 300-S₁, I-CSCF 300-I, S-CSCF 300-S₂, and/or P-CSCF 300-P₂may each include functionality implemented in multiple, different network devices, or in a same, single network device.

The configuration of network components of IMS network 115 shown in FIG. 3 is for illustrative purposes. Other configurations may be implemented. Therefore, IMS network 115 may include additional, fewer and/or different components that may be configured in a different arrangement than that depicted in FIG. 3.

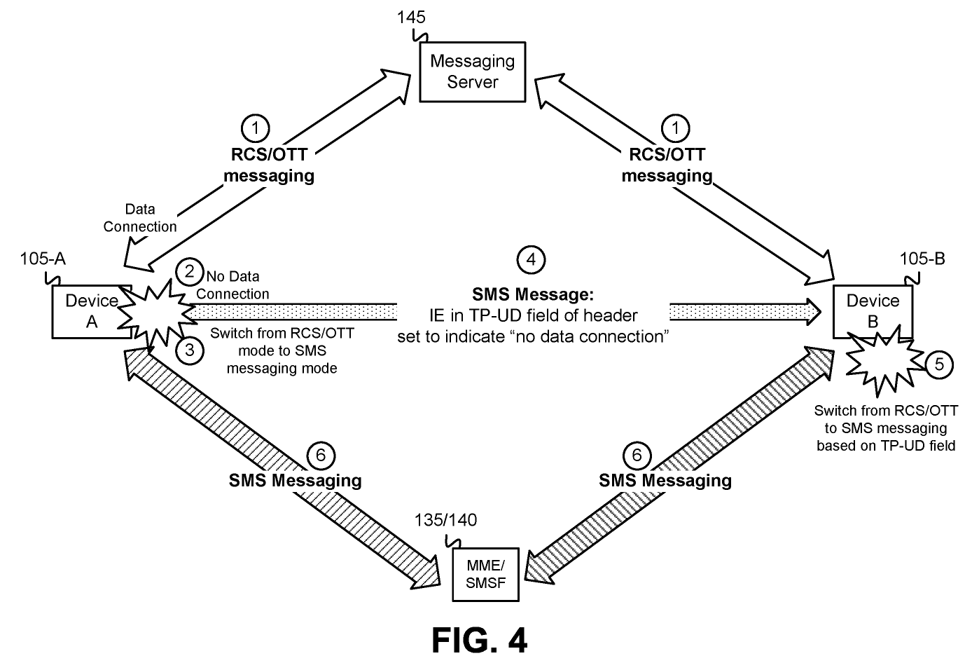

FIG. 4 depicts an example overview of a fallback process from RCS/OTT messaging to SMS messaging, as described in further detail herein. As shown, device 105-A may start with an existing data connection via either terrestrial mobile network(s) 110 or via WLAN 130-A. Using the existing data connection, device 105-A engages in RCS or OTT messaging (identified with a “1” within a circle) with device 105-B via an intermediary messaging server 145. In the case of RCS messaging, messaging server 145 includes an RCS messaging server. In the case of OTT messaging, messaging server 145 includes an OTT messaging server.

At some point in time, device 105-A may lose its data connection (identified with a “2” within a circle). For example, data service over terrestrial mobile network(s) 110 may be temporarily disrupted, WLAN 130-A may fail, or device 105-A may switch its active connection from terrestrial mobile network(s) 110, which has an operating data connection, to non-terrestrial mobile network 120, that does not have an operating data connection, or does not support a data connection at all (e.g., no service area). Upon determining that it no longer has a data connection, device 105-A switches (identified with a “3” within a circle) from RCS/OTT messaging mode to SMS messaging mode. In SMS messaging mode, device 105-A may generate, for example, an SMS message with an indicator in an Information Element (IE) of the Transfer Protocol-User Data (TP-UD) header field of the SMS message set to indicate that device 105-A currently has “no data connection.” Device 105-A then sends the SMS message (identified with a “4” within a circle) over NAS or IMS, with the “no data connection” indicator set, to device 105-B via, for example, terrestrial mobile network(s) 110 or non-terrestrial mobile network 120.

Upon receipt of the SMS message, and based on the “no data connection” indicator being set in the TP-UD header field, device 105-B switches (identified with a “5” within a circle) from RCS/OTT messaging mode to SMS messaging mode. Device 105-B may subsequently engage in SMS messaging (identified with a “6” within a circle) with device 105-A via MME 135/SMSF 140 (e.g., over NAS). Alternatively, device 105-B may engage in SMS over IMS messaging with device 105-A via CSCFs 300 of IMS network 115. Though not shown in FIG. 4, device 105-B may subsequently switch back to RCS/OTT messaging mode when one of the following occurs: a) device 105-A sends an RCS or OTT message to device 105-B; or b) device 105-B receives an updated RCS/OTT “on” status from messaging server 145 and/or mobile networks 110 or 120.

Though the example overview of FIG. 4 describes RCS/OTT to SMS over NAS fallback, the fallback process may be similarly applied to RCS/OTT to SMS over IMS since SMS over IMS and SMS over NAS have a common transport layer format. In this alternative implementation, upon determining that it no longer has a data connection, device 105-A may switch from RCS/OTT messaging mode to SMS over IMS messaging mode, and may send a “no data connection” indicator (e.g., set to one) in an IE of a header of SIP messaging sent via IMS network 115 to device 105-B. Device 105-B, upon receipt of the SIP messaging and identifying the set “no data connection” indicator (e.g., data indicator set equal to one) in the SIP messaging header, may switch from RCS/OTT messaging mode to SMS over IMS messaging mode. Device 105-B may send subsequent messages to device 105-A over IMS network 115 via SMS over IMS messaging.

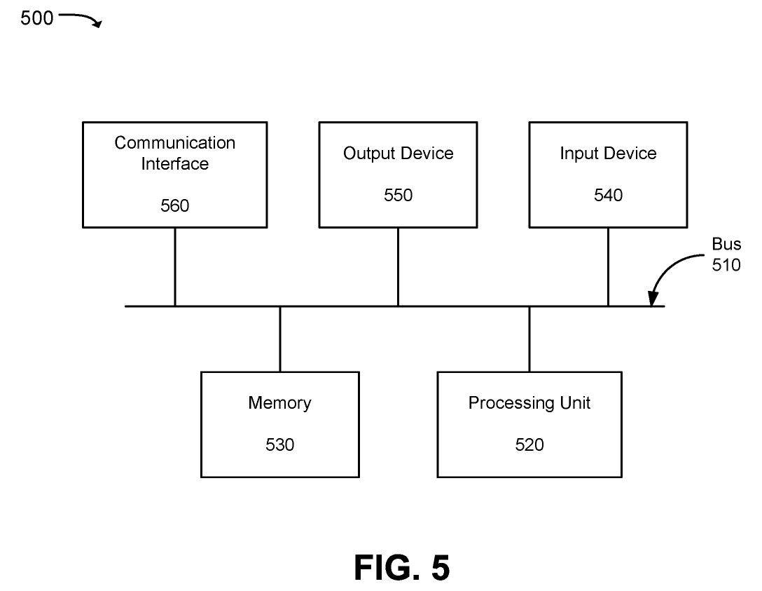

FIG. 5 is a diagram that depicts example components of a device 500. Devices 105, messaging server 145, and devices implementing (or executing functions associated with) AMF 225, PCF 230, UDM 235, SMF 240, UPF 245, SMSF 140, MME 135, HSS 275, SGW 265, PGW 270 may include components that are the same as, or similar to, those of device 500. A device(s) associated with the gNBs of Next Generation RAN 215, gNBs of NSA Next Generation RAN 205, or eNBs of LTE RAN 255 may be configured similarly to device 500. Device 500 may include a bus 510, a processing unit 520, a memory 530, an input device(s) 540, an output device(s) 550, and a communication interface 560.

Bus 510 may include a path that permits communication among the components of device 500. Processing unit 520 may include one or more processors or microprocessors, or processing logic, which may interpret and execute instructions. Memory 530 may include a random-access memory (RAM) or another type of dynamic storage device that may store information and instructions for execution by processing unit 520. Memory 530 may further include a Read Only Memory (ROM) device or another type of static storage device that may store static information and instructions for use by processing unit 520. Memory 530 may also include a magnetic and/or optical recording medium. Memory 530 may be referred to herein as a "tangible non-transitory computer-readable medium,” a “non-transitory computer-readable medium,” or a “non-transitory storage medium.” In some implementations, the processes/methods set forth herein can be implemented as instructions that are stored in memory 530 for execution by processing unit 520.

Input device 540 may include one or more mechanisms that permit an operator to input information into device 500, such as, for example, a keypad or a keyboard, a display with a touch sensitive panel, voice recognition and/or biometric mechanisms, etc. Output device 550 may include one or more mechanisms that output information to the operator, including a display, a speaker, etc. Input device 540 and output device 550 may, in some implementations, be implemented as a user interface (UI) that displays UI information and which receives user input via the UI. Communication interface 560 may include one or more transceivers that enable device 500 to communicate with other devices and/or systems. For example, communication interface 560 may include wired or wireless transceivers for communicating via Terrestrial mobile network(s) 110, IMS network 115, non-terrestrial mobile network 120, WLANs 130, or data network 125.

The configuration of components of device 500 illustrated in FIG. 5 is for illustrative purposes. Other configurations may be implemented. Therefore, device 500 may include additional, fewer and/or different components than those depicted in FIG. 5.

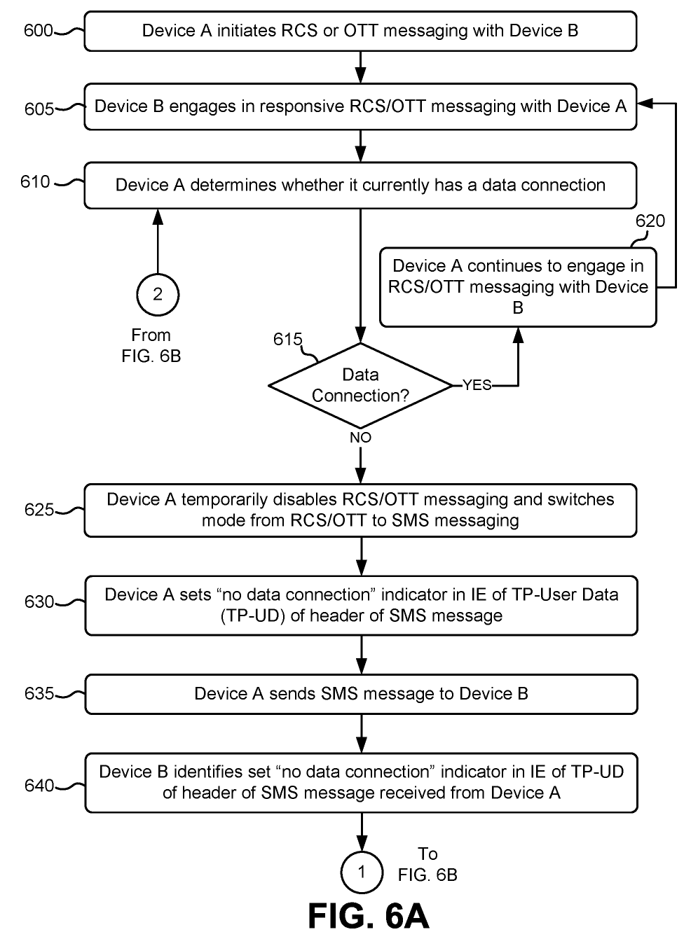

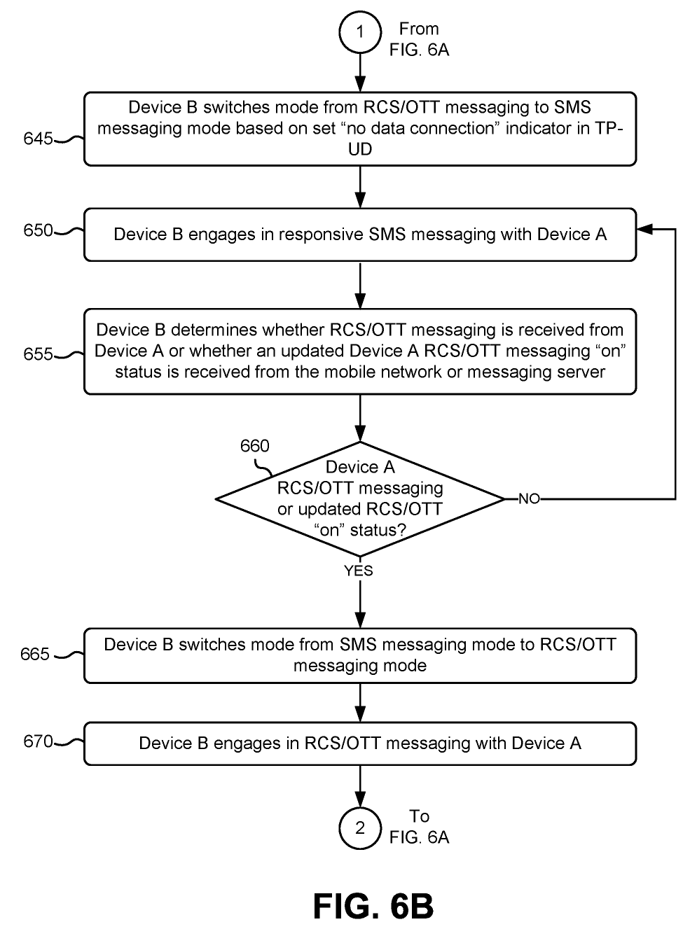

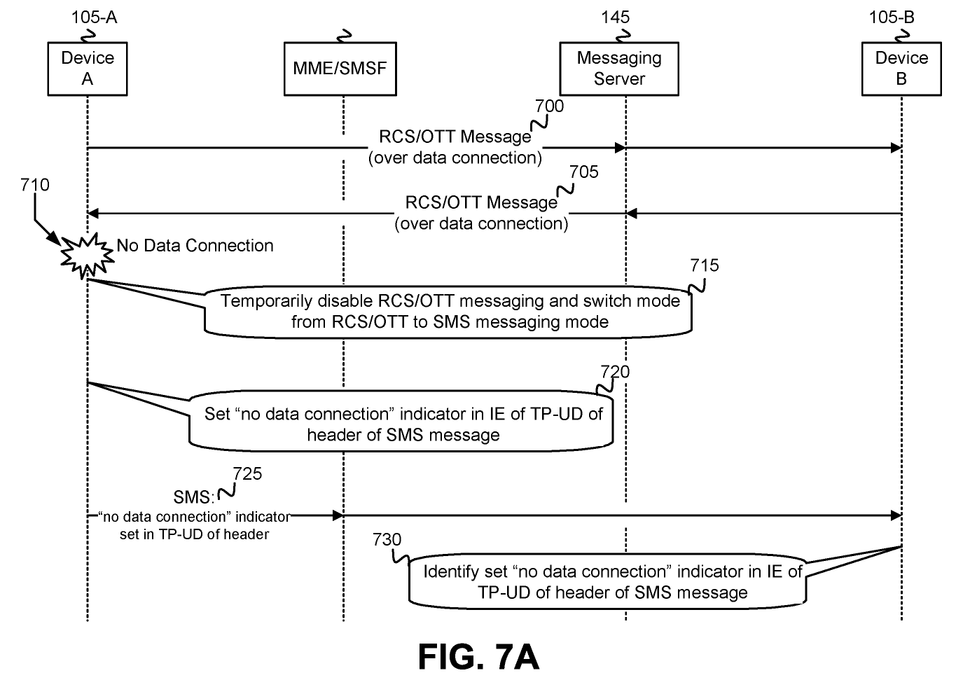

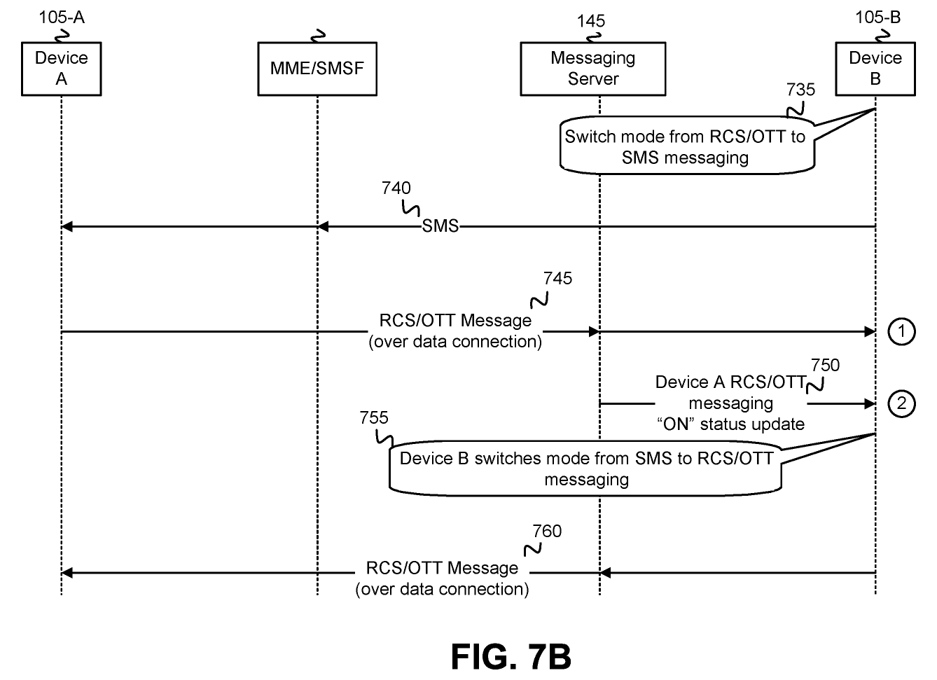

FIGS. 6A and 6B are flow diagrams of an example process for initiating RCS/OTT to SMS fallback based on the loss of a data connection at a wireless device. The example process of FIGS. 6A and 6B may be implemented by device 105-A and device 105-B. The example process of FIGS. 6A and 6B is described below with reference to the example messaging/operations/data flow diagrams of FIGS. 7A and 7B. The example process of FIGS. 6A and 6B may apply to either RCS/OTT to SMS over NAS fallback or RCS/OTT to SMS over IMS fallback.

The example process may include device 105-A initiating RCS or OTT messaging with device 105-B (block 600), and device 105-B engaging in responsive RCS/OTT messaging with device 105-A (block 605). If device 105-A has RCS capability, then device 105-A may initiate RCS messaging with device 105-B via RCS messaging server 145. If device 105-A has an OTT messaging application installed, then device 105-A may initiate OTT messaging with device 105-B via OTT messaging server 145. In the example depicted in FIG. 7A, device 105-A sends an RCS/OTT message 700 over a data connection to device 105-B via a messaging server 145. As further shown, device 105-B, responsive to RCS/OTT message 700, sends an RCS/OTT message 705 to device 105-A over a data connection.

Device 105-A determines whether it currently has a data connection (block 610). The data connection may be with a WLAN 130 (e.g., WLAN 130-A of FIG. 1), or a mobile network data connection over terrestrial mobile network(s) 110. If device 105-A currently has a data connection (YES-block 615), then device 105-A continues to engage in RCS/OTT messaging with device 105-B (block 620) and the process returns to block 605. If device 105-A currently does not have a data connection (NO-block 620), then device 105-A temporarily disables RCS/OTT messaging and switches mode from RCS/OTT messaging to SMS messaging (block 625) (e.g., over NAS or IMS). Device 105-A may, for example, lose its data connection over WLAN 130 and/or may lose its data connection over terrestrial mobile network(s) 110. Alternatively, device 105-A may not have a current data connection via WLAN 130-A (e.g., device 105-A moves outside of the wireless range of WLAN 130-A, or device 105-A is within wireless range of WLAN 130-A, but WLAN 130-A is overloaded with traffic or incurs a total failure) and may switch its mobile network connection from terrestrial mobile network(s) 110 to non-terrestrial mobile network 120, but non-terrestrial mobile network 120 may not support a mobile data connection and may only support a mobile voice connection (including supporting SMS messaging). FIG. 7A shows device 105-A determining that it currently has no data connection 710, temporarily disabling 715 RCS/OTT messaging and switching mode from RCS/OTT to SMS messaging.

Based on currently having no data connection, device 105-A sets a “no data connection” indicator in an Information Element (IE) of the Transfer Protocol-User Data (TP-UD) header field of a SMS message (block 630) and sends the SMS message to device 105-B (e.g., over NAS or IMS) (block 635). For example, any one of the IE indicators at 80-9F (hexidecimal) within the TP-UD header field may be set to one if device 105-A has “no data connection,” or may be reset to zero if device 105-A currently has a data connection. As described in Technical Specification (TS) 3GPP TS 23.040 V18.0.0, the IE octets at 80-9F (hexidecimal) may be reserved for Short Message Entity (SME) to SME specific use, and one of these octets may be reused for setting or resetting a “no data connection” indicator in the TP-UD header field of the SMS message. In other implementations, a different IE in the header of the SMS message may be used/re-used for specifying whether device 105-A currently has, or does not have, a data connection. FIG. 7A depicts device 105-A setting 720 a “no data connection” indicator in an IE of TP-UD of the header of a SMS message, and sending the SMS message 725 to device 105-B via MME 135/SMSF 140.

Device 105-B identifies the set “no data connection” indicator in the IE of the TP-UD of the header of the SMS message received from Device 105-A (block 640), switches mode from RCS/OTT messaging to SMS messaging based on the set “no data connection” indicator in the TP-UD (block 645)(FIG. 6B), and engages in responsive SMS messaging (e.g., over NAS or IMS) with device 105-A (block 650). Device 105-B, therefore, switches a current messaging session, initiated in blocks 600 and 605 using RCS/OTT messaging, for continuance as a SMS messaging session. FIG. 7A illustrates device 105-B identifying 730 the set “no data connection” indicator in the IE of TP-UD of the header of the SMS message. FIG. 7B further depicts device 105-B switching mode 735 from RCS/OTT to SMS messaging and sending a responsive SMS message 740 to device 105-A via MME 135/SMSF 140.

Device 105-B determines whether RCS/OTT messaging is subsequently received from device 105-A or whether an updated device 105-A RCS/OTT messaging “on” status is received from mobile networks 110 or 120 or from messaging server 145 (block 655). Subsequent to switching mode from RCS/OTT messaging to SMS messaging, device 105-A may regain its data connection, switch back to RCS/OTT messaging mode from SMS messaging mode, and send a subsequent RCS/OTT message(s) to device 105-B. Alternatively, messaging server 145 may keep track of the RCS/OTT status of device 105-A and when device 105-A regains its data connection, messaging server 145 may send an updated status to device 105-B. FIG. 7B shows a first circumstance (identified with a “1” within a circle) in which device 105-A regains its data connection, switches back to RCS/OTT messaging mode, and sends an RCS/OTT message 745 over the data connection to device 105-B via messaging server 145. FIG. 7B shows a second circumstance (identified with a “2” within a circle) in which messaging server 145 sends a device 105-A RCS/OTT messaging “on” status update 750 to device 105-B.

If RCS/OTT messaging is not received from device 105-A and an updated device 105-A RCS/OTT messaging “on” status is not received from mobile networks 110 or 120 or from messaging server 145 (NO-block 660), then the example process returns to block 650. If RCS/OTT messaging is received from device 105-A or an updated device 105-A RCS/OTT messaging “on” status is received from mobile networks 110 or 120 or from messaging server 145 (YES-block 660), then device 105-B switches mode from SMS messaging mode back to RCS/OTT messaging mode (block 665) and engages in RCS/OTT messaging with device 105-A (block 670). The example process returns to block 610 of FIG. 6A. FIG. 7B depicts device 105-B switching mode 755 from SMS messaging to RCS/OTT messaging, and device 105-B sending a responsive RCS/OTT message 760, over a data connection, to device 105-A.

The foregoing description of implementations provides illustration and description, but is not intended to be exhaustive or to limit the invention to the precise form disclosed. Modifications and variations are possible in light of the above teachings or may be acquired from practice of the invention. For example, while a series of blocks has been described with respect to FIGS. 6A and 6B, and a sequence of operations, messages, and/or data flows with respect to FIGS. 4, 7A, and 7B, the order of the blocks and/or the operations, messages, and/or data flows may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processing unit 520) of a device. A non-transitory storage medium includes one or more of the storage mediums described in relation to memory 530. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article "a" is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
engaging, by a first device, in Rich Communication Services (RCS) or Over-the-Top (OTT) messaging with a second device;
determining, by the first device, that it no longer has a data connection;
disabling, by the first device, the RCS or OTT messaging;
setting, by the first device, an indicator, that indicates that the first device has no data connection, in an information element of a header field of a Short Message Service (SMS) message; and
sending, by the first device, the SMS message to the second device.

2. The method of claim 1, further comprising:
receiving, by the first device from the second device, at least one responsive SMS message,
wherein the SMS message comprises an SMS over Non-Access Stratum (NAS) message and the at least one responsive SMS message comprises at least one SMS over NAS message.

3. The method of claim 1, further comprising:
receiving, by the first device from the second device, at least one responsive SMS message,
wherein the SMS message comprises an SMS over Internet Protocol (IP) Multimedia Subsystem (IMS) message and the at least one responsive SMS message comprises at least one SMS over IMS message.

4. The method of claim 1, wherein the data connection comprises a terrestrial mobile network data connection or a Wireless Local Area Network (WLAN) data connection.

5. The method of claim 1, wherein the header field of the SMS message comprises a Transfer Protocol-User Data (TP-UD) header field of the SMS message.

6. The method of claim 5, wherein the information element comprises one or more octets in the TP-UD header field.

7. The method of claim 1, wherein determining that the first device no longer has the data connection further comprises:
determining, by the first device, that it no longer has a Wireless Local Area Network (WLAN) data connection;
determining, by the first device, that it no longer has a terrestrial mobile network data connection; or
determining, by the first device, that it has a non-terrestrial mobile network connection, instead of a terrestrial mobile network data connection, that does not support mobile data.

8. A first device, comprising:
at least one communication interface; and
a processing unit configured to:
engage in Rich Communication Services (RCS) or Over-the-Top (OTT) messaging with a second device via the at least one communication interface,
determine that the first device no longer has a data connection,
disable RCS or OTT messaging,
set an indicator, that indicates that the first device has no data connection, in an information element of a header field of a Short Message Service (SMS) message, and
send, via the at least one communication interface, the SMS message to the second device.

9. The first device of claim 8, wherein the processing unit is further configured to:
receive, from the second device via the communication interface, at least one responsive SMS message,
wherein the SMS message comprises an SMS over Non-Access Stratum (NAS) message and the at least one responsive SMS message comprises at least one SMS over NAS message.

10. The first device of claim 8, wherein the processing unit is further configured to:
receive, from the second device via the communication interface, at least one responsive SMS message,
wherein the SMS message comprises an SMS over Internet Protocol (IP) Multimedia Subsystem (IMS) message and the at least one responsive SMS message comprises at least one SMS over IMS message.

11. The first device of claim 8, wherein the data connection comprises a terrestrial mobile network data connection or a Wireless Local Area Network (WLAN) data connection.

12. The first device of claim 8, wherein the header field of the SMS message comprises a Transfer Protocol-User Data (TP-UD) header field of the SMS message.

13. The first device of claim 12, wherein the information element comprises one or more octets in the TP-UD header field.

14. The first device of claim 8, wherein, when determining that the first device no longer has the data connection, the processing unit is further configured to:
determine that the first device no longer has a Wireless Local Area Network (WLAN) data connection;
determine that the first device no longer has a terrestrial mobile network data connection; or
determine that the first device has a non-terrestrial mobile network connection, instead of a terrestrial mobile network data connection, that does not support mobile data.

15. A non-transitory storage medium storing instructions executable by a first device, wherein execution of the instructions causes the first device to:
engage in Rich Communication Services (RCS) or Over-the-Top (OTT) messaging with a second device;
determine that the first device no longer has a data connection;
disable RCS or OTT messaging;
set an indicator, that indicates that the first device has no data connection, in an information element of a header field of a Short Message Service (SMS) message; and
send the SMS message to the second device.

16. The non-transitory storage medium of claim 15, wherein execution of the instructions further causes the first device to:
receive, from the second device, at least one responsive SMS message,
wherein the SMS message comprises an SMS over Non-Access Stratum (NAS) message and the at least one responsive SMS message comprises at least one SMS over NAS message.

17. The non-transitory storage medium of claim 15, wherein execution of the instructions further causes the first device to:
receive, from the second device, at least one responsive SMS message,
wherein the SMS message comprises an SMS over Internet Protocol (IP) Multimedia Subsystem (IMS) message and the at least one responsive SMS message comprises at least one SMS over IMS message.

18. The non-transitory storage medium of claim 15, wherein the header field of the SMS message comprises a Transfer Protocol-User Data (TP-UD) header field of the SMS message.

19. The non-transitory storage medium of claim 18, wherein the information element comprises one or more octets in the TP-UD header field.

20. The non-transitory storage medium of claim 15, wherein execution of the instructions to cause the first device to determine that the first device no longer has the data connection further causes the first device to:
determine that the first device no longer has a Wireless Local Area Network (WLAN) data connection;
determine that that first device no longer has a terrestrial mobile network data connection; or
determine that the first device has a non-terrestrial mobile network connection, instead of a terrestrial mobile network data connection, that does not support mobile data.
